(19) United States
(12) Patent Application Publication
(10) Pub. No.: US 2019/0102763 A1
(43) Pub. Date: Apr. 4, 2019

(54) SYSTEM AND METHOD FOR SELF-PUBLICATION AND DISTRIBUTION OF DIGITAL CONTENT VIA THE INTERNET

(71) Applicant: Cosmin-Gabriel ENE, München (DE)

(72) Inventor: Cosmin-Gabriel ENE, München (DE)

(21) Appl. No.: 16/094,569

(22) PCT Filed: Apr. 19, 2017
(86) PCT No.: PCT/EP2017/059314

§ 371 Date: Oct. 18, 2018

Related U.S. Application Data
(60) Provisional application No. 62/324,437, filed on Apr. 19, 2016.

(51) Int. Cl. G06Q 20/12; G06F 16/955; G06Q 30/02; G06Q 20/14; G06Q 50/00; H04L 29/08

(52) U.S. Cl. CPC G06Q 20/123; G06F 16/9566; G06Q 30/0279; H04L 67/20; G06Q 50/01; H04L 67/10; G06Q 20/14

(57) ABSTRACT

An internet-accessible computer server has a processor, a receiver, a transmitter and a memory. The receiver is coupled to the processor and receives: a) login information from a user over the internet, b) information to access digital content stored by the user on an internet-accessible remote storage server and c) at least one price attribute to be associated with offering access to the digital content to third parties in, for example, a social media network. The processor creates a webpage for presenting the digital content and causes the transmitter to transmit a unique identifier of the webpage to the user for posting on, for example, the social media platform. The receiver receives a third-party request for the content via the identifier, causing the transmitter transmits a link to the third-party for accessing an online payment transaction system to pay for the content. Upon receiving a payment confirmation from that system, the processor retrieves the digital content a remote storage system used by the user and causes the transmitter to transmit the content to the third-party.

### FIELD OF THE INVENTION

This disclosure pertains to a system and method for third-party access to original digital content identified on a social media platform.

### BACKGROUND

Today, internet-based shopping systems are becoming increasingly popular for providing internet users a quick and convenient method of purchasing various goods and services. These systems allow user to purchase various good and services by placing them in a virtual shopping cart and then pay for the items at the end of the shopping procedure. However, these systems are not particularly well-suited as a mechanism for enabling individual sellers and business entities to rapidly enable the sale of digital content, e.g., images, photographs, videos, electronic documents and software, shortly after its creation.

Such systems are further not particularly well-suited for providing access to digital content provided by users for third-party purchase on social media platforms such as FACEBOOK, GOOGLE+, TWITTER, LINKEDIN, INSTAGRAM, and the like, where spontaneity and speed of interaction are typically of high importance to participants. Accordingly, conventional internet shopping platforms and the present-day internet have created a problem of providing great difficulty for users to make their digital content readily accessible to others in a controlled manner and in a way that enables such users to receive some compensation for their digital content contributions without digital media providers incurring undesirable administrative overhead and delay.

### SUMMARY

Briefly, the problem created by conventional internet shopping platforms and the present-day internet are solved by the aspects of the system and method according to the present disclosure. Specifically, the present disclosure is directed to an internet-accessible server and associated operating method that enable users to self-publish and distribute digital content residing on internet-accessible remote digital storage servers available to third parties via the internet.

By way of example, aspects of the present disclosure are directed to an internet-accessible computer server having a processor, a receiver, a transmitter and a memory. The receiver is coupled to the processor and configured to receive login information from, for example, a user over the internet to be processed by the processor to provide access to an account of the user. Once the account is verified, the receiver is configured to receive from the user (a) information to access digital content stored by the user on an internet-accessible remote digital storage server (for example, a cloud-based remote storage server such as DROPBOX, GOOGLE DRIVE, ICLOUD, MICROSOFT ONEDRIVE or the like) and (b) at least one price attribute to be associated with offering access to the digital content to third parties in the social media network. The digital content include any type of media content that is maintained in the form of digital data, for example, including images, video, audio and/or software content.

The memory is coupled to the processor and configured to store a webpage created by the processor for presenting the digital content to the third parties. The webpage has a unique webpage address including information about the digital content being offered by the user (for example, including at least a preview image, the price attribute and a webpage link).

The processor is further coupled to the transmitter, which is coupled to the internet for transmitting the unique webpage identifier to the user for posting, for example, via the social media platform for access by third parties. Once posted, the receiver is configured to receive a request by a third-party via the webpage link (which has been posted by the user on the social media site). In response to the request, the processor causes the transmitter to transmit a link to the third-party for accessing an online payment transaction system (for example, such as LATERPAY, PAYPAL or the like). In response to receiving a transaction confirmation from the online payment transaction system, the processor may then cause the receiver and transmitter to retrieve the digital content from a user storage area on the remote storage server and transmit the digital content to the third-party.

According to a second aspect of the present disclosure, the processor may alternatively cause the receiver and transmitter to transmit information to the third-party for third-party retrieval of the digital content from the user storage area on the remote storage server.

According to another aspect of the present disclosure, for the purpose of discouraging unauthorized copying of an image or other digital media type by third parties, the preview image may include a watermark or text/symbol marking superimposed on the image. Alternatively, the preview image may include a blurred or otherwise distorted appearance.

According to another aspect of the present disclosure, the pricing attribute may include one or more prices from a pricing schedule, associated with one or more of a personal use license or commercial use license. Alternatively or in addition, the pricing attribute may include a donation attribute pertaining to a charity or campaign.

According to yet another aspect of the present disclosure, the transaction confirmation may confirm a one-time payment, or alternatively confirm both present and future payment agreements according to particular terms and conditions.

According to another aspect of the present disclosure, the transaction provided by the payment transaction system may advantageously be performed according to a method that includes the steps of: a) storing an identification number of a buyer system by which internet-accessible commerce systems including at least the digital content distribution server, enables a purchase to be made at the level of a certain purchase amount, the identification number includes a hardware identification number that at least a portion of a MAC address and/or a processor identification number and/or a controller identification number and/or a disk ID number and/or an IP address includes, b) storing the purchase amount in association with the identification number by the payment transaction system, c) monitoring the total amount of the buyer system purchases made through the payment transaction system, d) issuing, to a user of the internet-accessible commerce systems, a request for settlement of at least part of the total payable when the total payable amount exceeds a predetermined value and/or after a predetermined time interval has elapsed.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect.” The aspects described above and other aspects of the present disclosure described herein are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 is a schematic diagram showing an exemplary digital content distribution system according to aspects of the present disclosure;

FIG. 2 is a flow diagram illustrating the operation of the exemplary content distribution system; and

FIG. 3 is a flow diagram illustrating the operation of an exemplary digital content distribution server according to aspects of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

As used herein, directional terms as may be used such as “horizontal,” “vertical,” “proximal,” “distal,” “front”, “rear”, “left,” “right,” “inner,” “outer,” “interior” and “exterior” relate to an orientation of the disclosed system, and do not specify permanent, intrinsic features or characteristics of the device.

In accordance with aspects of the present disclosure, we first describe an exemplary digital content distribution system 100 according to aspects of the present disclosure. The system 100 includes a digital content distribution server 110 coupled to a server database 120 and having access to an internet-accessible network 160. Also having access to the internet-accessible network 160 are a user access device 140 and at least one third-party access device 150, each of which having access to at least one social media platform (for example, FACEBOOK, GOOGLE+, TWITTER, LINKEDIN, INSTAGRAM or the like) via the internet-accessible network 160. Each of the user access devices 140 and at least one third-party access device 150 may include one of a number of conventional internet-accessible devices suitable for communications with a social media platform including, for example, personal computers, smart phones, tablets, phablets, smart watches and the like. One or more of the user access devices 140 or third-party access device 150 may preferably provide users with access to a commercially-available intelligent personal digital assistant (PDA) including, for example, AMAZON's ALEXA/ECHO, APPLE's SIRI, MICROSOFT's CORTANA and GOOGLE's GOOGLE HOME. An associated voice service product (for example, AMAZON's ALEXA VOICE SERVICE in the case of AMAZON's ALEXA/ECHO) may reside on an associated server or on the digital content distribution server 110.

The user access device 140 also has access to a user-associated remote storage system 130, which may preferably include a cloud-based remote storage system on which the user has an account for storing digital files for selective sharing with third-parties (for example, a cloud-based remote storage server such as DROPBOX, GOOGLE DRIVE, ICLOUD, MICROSOFT ONEDRIVE or the like).

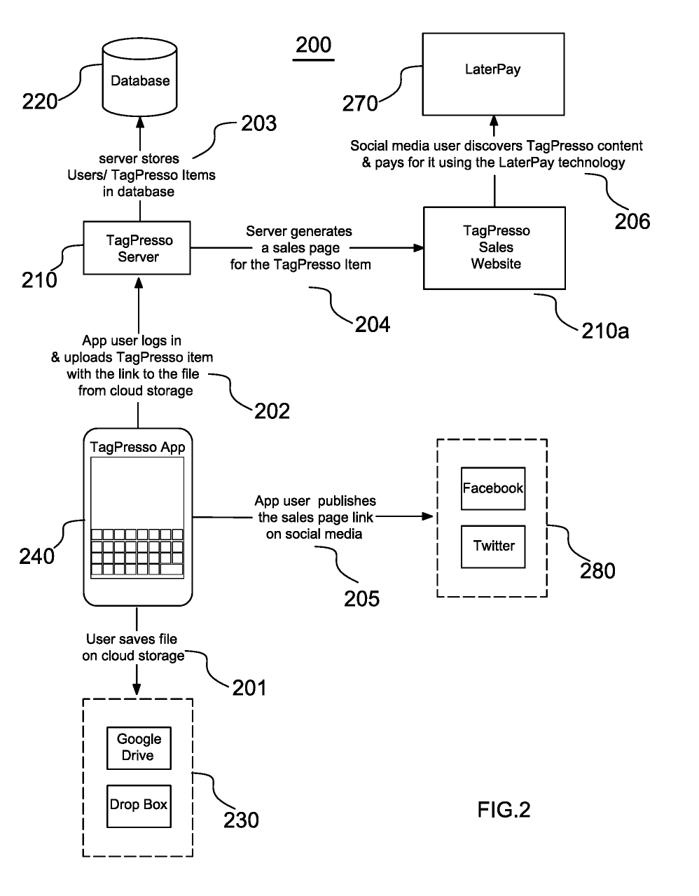

FIG. 2 illustrates an exemplary process 200 for operating a content distribution system in accordance with aspects of the present disclosure. At step 201 of the process 200, the user selects a file (for example, an image file associated with a photograph created by a camera component of the user access device 240), and saves the image file digitally by accessing user-associated remote storage system 230. The user may accomplish this, for example, by physically manipulating a user interface presented on the user access device 240, or alternatively by voice instructions interpreted by a PDA component of the user access device 240. User access device 240 obtains access information for the stored digital file from the user-associated remote storage system 230, and at step 202 logs into the digital content distribution server 210 to create a sales page request for enabling the image file to be offered for sale or license on a social media platform. The sales page request includes the access information for the stored image file.

At step 203 of the process 200, the digital content distribution server 210 stores the request and access information in a server database 220 containing account information of the user. The server 210 then generates a sales page 204 for access via a sales page website 210a, which is preferably administered by the server 210. The generated sales page 204 has a corresponding generated unique URL. The server 210 then transmits a sales page link for the generated URL to the user access device 240, enabling the user access device 240 at step 205 to publish the link on social media site 280. The description of sending the link to one or more social media platforms in step 205 is for illustration purposes only and it should be readily understood that the user may, in accordance with the invention, alternatively post or publish such link on any internet-accessible webpage viewable by third parties including, for example, non-social media-based webpages, email and other electronic messages.

In response to the publication of the link on social media site 280 or other posting accessible to third parties, a third-party request for the digital file is received at the sales page website 280. In response, the digital content distribution server 210 provides the third-party access (via third-party access device 150) with a link to a payment transaction system 270. In a preferred aspect of the present disclosure, the payment transaction system is advantageously a system provided by Laterpay GmbH of Munich, Germany. The Laterpay system provides the advantage of enabling purchasers to complete purchase transactions on low cost items and deferring payments to Laterpay until certain accumulated payment thresholds are reached (for example, deferring payment on a series of $0.10 charges until a threshold of $5.00 in accumulated charges is exceeded).

The operation of the Laterpay system is described, for example, in U.S. Patent Publication No. US 2012/0166339 A1 to the inventor of the invention, C. Ene, and which published on Jun. 28, 2012 and is hereby incorporated by reference in its entirety herein. The system operation may preferably include the following steps: a) storing an identification number of a buyer system by which internet-accessible commerce systems including at least the digital content distribution server, enables a purchase to be made at the level of a certain purchase amount, the identification number includes a hardware identification number that at least a portion of a MAC address and/or a processor identification number and/or a controller identification number and/or a disk ID number and/or an IP address includes, b) storing the purchase amount in association with the identification number by the payment transaction system, c) monitoring the total amount of the buyer system purchases made through the payment transaction system, d) issuing, to a user of the internet-accessible commerce systems, a request for settlement of at least part of the total payable when the total payable amount exceeds a predetermined value and/or after a predetermined time interval has elapsed.

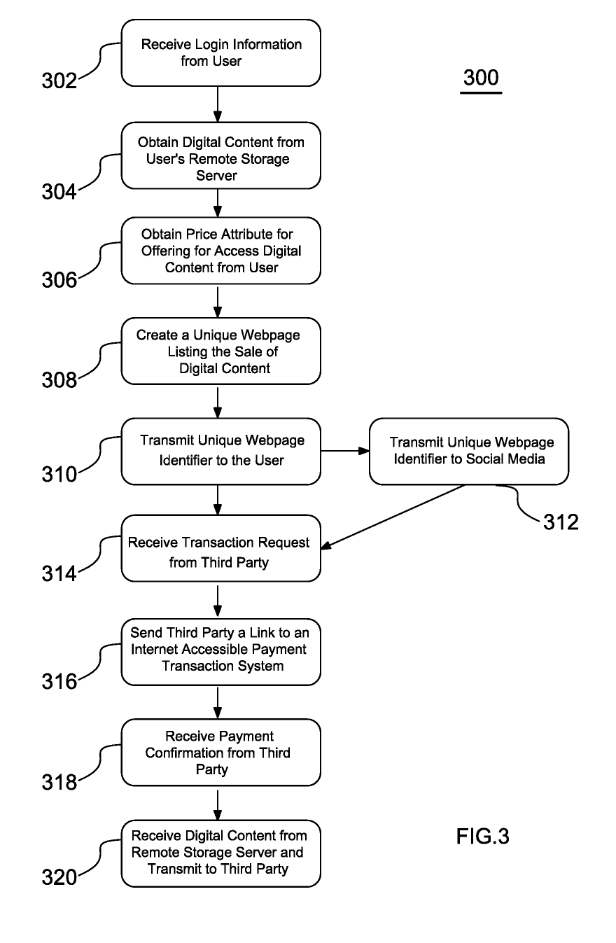

FIG. 3 depicts an operations process 300 for a content distribution system in accordance with aspects of the present disclosure and provides further detail with regard to operations of the digital content distribution server 210. At step 302 of the process 300, the server 210 of FIG. 2 receives login information from the user access device 240 authenticating the user to the server 210. This login information may be provided in number of ways, for example, including by physically manipulating the user interface presented on the user access device 240, by issuing voice instructions interpreted by the PDA component of the user access device 240, or automatically by the user access device 240. At step 304 of FIG. 3, the server 210 obtains from the user access device 240 the digital content to be presented on the sales page of the sales page website 210a. Alternatively, the server 210 may receive and store a link to access the digital content via the user-associated remote storage 230. At step 306 of FIG. 3, the server 210 obtains price attribute information from the user access device 240, which may include may include one or more prices from a pricing schedule associated with a personal use license or commercial use license. Alternatively or in addition, the pricing attribute may include a donation(s) attribute pertaining to a charity or campaign, such as a political campaign, or a user selection provided via voice instructions interpreted by the PDA component of the user access device 240.

At step 308 of FIG. 3, the digital content distribution server 210 creates a web page specific or unique to the digital content file which will be used to offer its sale to third parties via the sales page website 210a. At step 310, the server 210 transmits a link to the unique web page to the user access device 240, so that it may be transmitted, for example, at step 312 by the device 240 to one or more social media platforms that the user has joined (for example, including one or more of FACEBOOK, GOOGLE+, TWITTER, LINKEDIN, INSTAGRAM, and the like). The description of sending the link to one or social media platforms in step 312 is for illustration purposes only and it should be readily understood that the user may, in accordance with the invention, alternatively post or publish such link on any internet-accessible webpage viewable by third parties including, for example, non-social media-based webpages, email and other electronic messages.

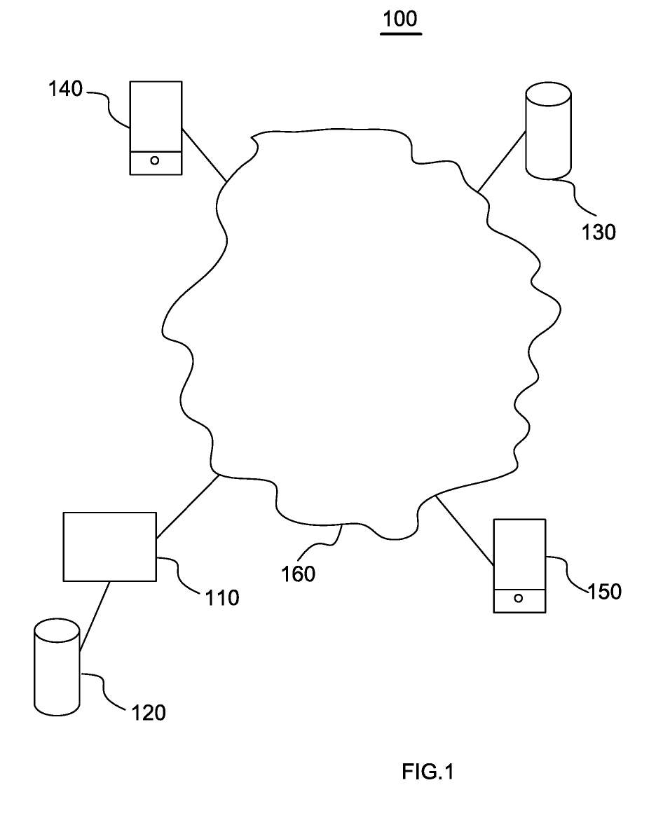

At step 314 of FIG. 3, the server 210 receives a third-party transaction request via the website 210a from the third-party access device 150 of FIG. 1. A third party may initiate the request in a variety of ways including, for example, by issuing voice instructions interpreted by a PDA component of the third-party access device 150. At step 316 of FIG. 3, the server 210 sends a payment link to the device 150 for accessing the internet-accessible payment transaction system 270 of FIG. 2. At step 318 of FIG. 3, the server 210 receives confirmation of payment from the payment transaction system 270. Confirmation may be provided as to a one-time payment, or alternatively as to both present and future payment agreements according to particular terms and conditions.

Once payment is received by the digital content distribution server 210 at step 318, the server 210 proceeds at step 320 to provide the digital content to the third-party access device 150 of FIG. 1. The server 210 accomplish step 320 by first retrieving the digital content from the user-associated remote storage 230 of FIG. 2 (for example, either as a complete file or in segments for streaming over the internet-based network 106 of FIG. 1), and then transmitting the digital content to the third-party access device 150. Alternatively, the server 210 transmits information to the third-party access device 150 (for example, an active link) for direct retrieval of the digital file firm the user-associated remote storage 230 of FIG. 2 by the third-party access device 150.

It should be further understood that the digital content distribution server 110 in FIGS. 1 and 210 in FIG. 2 or associated processing system may also enable third parties to search the collection or aggregate of user created sales webpages for possible digital content to acquire.

### REFERENCE CHARACTER TABLE

The following table lists the reference characters and names of features and elements used herein: Reference characters assigned to method steps are not listed.

| Ref. char. | Feature or element |
|---|---|
| 100 | Digital content distribution system |
| 110 | Digital content distribution server |
| 120 | Server database |
| 130 | User-associated remote storage |
| 140 | User access device |
| 150 | Third-party access device |
| 160 | Internet-accessible network |
| 210 | Digital content distribution server |
| 210a | Sales page website |
| 220 | Server database |
| 230 | User-associated remote storage |
| 240 | User access device |
| 270 | Payment transaction system |
| 280 | Social media site |

It will be understood that, while various aspects of the present disclosure have been illustrated and described by way of example, the invention claimed herein is not limited thereto, but may be otherwise variously embodied within the scope of the following claims. For example, it should be understood that digital content distribution server and associated methods could be used in support of other applications, for example, including e-mail mass marketing.

1. A method for an internet-accessible digital content distribution server, the method comprising the steps of:
receiving over the internet login information from a user to remotely access an account of said user;
receiving from the user, information to access digital content residing on an internet-accessible remote storage server, the digital content being associated with the user;
receiving from said user at least one price attribute to be associated with offering access to the digital content;
creating and storing in memory associated with the server, a new webpage having a unique webpage address, said webpage including information about the digital content including at least a preview image associated with the digital content and the at least one price attribute;
transmitting the unique webpage identifier to the user;
in connection with an internet-accessible social media posting of the unique webpage address by the user, receiving a webpage request from a third-party and transmitting the information for the unique webpage to the third-party;
receiving from the third-party over the internet, a transaction request for said digital content;
in response to said transaction request, sending the third-party a link to an internet-accessible payment transaction system;
receiving transaction confirmation from the payment transaction system; and
retrieving said digital content from the remote storage server and transmitting the digital content to the third-party in response to receiving the transaction confirmation from the payment transaction system.

2. The method of claim 1 wherein the transmitting the unique webpage identifier to the user step includes transmitting the preview image.

3. The method of claim 2 wherein the preview image includes a watermark or text superimposed thereon.

4. The method of claim 2 wherein at least a portion of the preview image comprises a blurred appearance.

5. The method of claim 1 wherein the unique webpage address is created for respective single digital content.

6. The method of claim 1 wherein the pricing attribute includes pricing for personal use of the digital content.

7. The method of claim 1 wherein the pricing attribute includes pricing for commercial use of the digital content.

8. The method of claim 1 wherein the pricing attribute comprises a donation attribute.

9. The method of claim 8 wherein the donation attribute is for a charity or campaign.

10. The method of claim 1 wherein the transaction confirmation from the online payment transaction system is represents a commitment for future payment under particular terms and conditions.

11. The method of claim 10 wherein the transaction confirmation is produced by the payment transaction system according to a method comprising the steps of:
a. storing an identification number of a buyer system by which internet-accessible commerce systems including at least the digital content distribution server, enables a purchase to be made at the level of a certain purchase amount, the identification number includes a hardware identification number that at least a portion of a MAC address and/or a processor identification number and/or a controller identification number and/or a disk ID number and/or an IP address includes;
b. storing the purchase amount in association with the identification number by the payment transaction system;
c. monitoring the total amount of the buyer system purchases made through the payment transaction system; and
d. issuing, to a user of the internet-accessible commerce systems, a request for settlement of at least part of the total payable when the total payable amount exceeds a predetermined value and/or after a predetermined time interval has elapsed.

12. An internet-accessible computer server for transactions of digital content, the server comprising:
a processor;
a receiver coupled to the processor and configured to couple to an internet, said receiver further configured to receive login information from a user over the internet to be processed by the processor to provide access to an account of said user, said receiver further configured to receive from the user (a) information to access digital content stored on an internet-accessible remote storage server, the digital content being associated with the user, and (b) at least one price attribute to be associated with offering access to the digital content;
memory coupled to the processor and configured to store a new webpage created by said processor; said new webpage having a unique webpage address and including information about the digital content including at least a preview image associated with the digital content and the at least one price attribute;
a transmitter coupled to the processor and configured to connect to the internet, said processor further configured to cause the transmitter to transmit the unique webpage identifier to the user;
wherein, in connection with an internet-accessible social media posting of the unique webpage address by the user, and in response to said receiver receiving a webpage request from a third-party; the processor being configured to cause transmitter to transmit the information for the unique webpage to the third-party;
wherein, in response to receiving from the third-party over the internet, a transaction request for said digital content, the processor being configured to cause transmitter to transmit the third-party a link to an online payment transaction system; and
wherein, in response to transaction confirmation from the online payment transaction system, the processor being configured to cause the receiver and transmitter to retrieve said digital content from the remote storage server and transmit the digital content to the third-party.

13. The server of claim 12 further comprising an internet-accessible payment system, the payment system comprising:
a. an identification device for recording at least one identification number of a shopper system, wherein the identification device provides a program which can be executed on the shopper system to record the at least one identification number, the identification number comprising a hardware identification number, the hardware identification number comprising at least part of a MAC address and/or a processor identification number and/or a controller identification number and/or a hard disk identification number and/or an IP address;
b. an interface device for receiving and confirming direct debit orders from at least one internet-accessible commerce system including the server, wherein the debit orders comprise information relating to a debit amount to be paid to the at least one commerce system;
c. a memory device for storing the direct debit orders in conjunction with the associated identification numbers;
d. a payment processor which is configured to monitor the total payable of the debit amounts in relation to the identification number and to request a user of the shopper system to register after a predetermined time interval and/or on exceeding a predetermined value of the total payable, in order to settle at least part of the total payable.

14. A method for an internet-accessible digital content distribution server, the method comprising the steps of:
receiving over the internet login information from a user to remotely access an account of said user;
receiving from the user, information to access digital content residing on an internet-accessible remote storage server, the digital content being associated with the user;
receiving from said user at least one price attribute to be associated with offering access to the digital content;
creating and storing in memory associated with the server, a new webpage having a unique webpage address, said webpage including information about the digital content including at least a preview image associated with the digital content and the at least one price attribute;
transmitting the unique webpage identifier to the user;
in connection with an internet-accessible social media posting of the unique webpage address by the user, receiving a webpage request from a third-party and transmitting the information for the unique webpage to the third-party;
receiving from the third-party over the internet, a transaction request for said digital content;
in response to said transaction request, sending the third-party a link to an internet-accessible payment transaction system;
receiving transaction confirmation from the payment transaction system; and
transmitting information for retrieving said digital content from the remote storage server to the third-party in response to receiving the transaction confirmation from the payment transaction system.

15. An internet-accessible computer server for transactions of digital content, the server comprising:
a processor;
a receiver coupled to the processor and configured to couple to an internet, said receiver further configured to receive login information from a user over the internet to be processed by the processor to provide access to an account of said user, said receiver further configured to receive from the user (a) information to access digital content stored on an internet-accessible remote storage server, the digital content being associated with the user, and (b) at least one price attribute to be associated with offering access to the digital content;
memory coupled to the processor and configured to store a new webpage created by said processor; said new webpage having a unique webpage address and including information about the digital content including at least a preview image associated with the digital content and the at least one price attribute;
a transmitter coupled to the processor and configured to connect to the internet, said processor further configured to cause the transmitter to transmit the unique webpage identifier to the user;
wherein, in connection with an internet-accessible social media posting of the unique webpage address by the user, and in response to said receiver receiving a webpage request from a third-party; the processor being configured to cause transmitter to transmit the information for the unique webpage to the third-party;
wherein, in response to receiving from the third-party over the internet, a transaction request for said digital content, the processor being configured to cause transmitter to transmit the third-party a link to an online payment transaction system; and
wherein, in response to transaction confirmation from the online payment transaction system, the processor being configured to cause the receiver and transmitter to transmit information for retrieving said digital content from the remote storage server to the third-party.
